(19) United States
(12) Patent Application Publication
(10) Pub. No.: US 2009/0223779 A1
(43) Pub. Date: Sep. 10, 2009

(54) Conveyor Diverter

(76) Inventors: Stephen D. Szarkowski, Pueblo, CO (US); Rodney R. Mishmash, Pueblo, CO (US); David M. Pruett, Canon City, CO (US); Raymond D. Middlemiss, Canon City, CO (US); Thomas Harding, Canon City, CO (US)

Correspondence Address: KLAAS, LAW, O''MEARA & MALKIN, P.C., 1999 BROADWAY, SUITE 2225, DENVER, CO, 80202, US

(21) Appl. No.: 12/091,676

(22) PCT Filed: Apr. 23, 2007
(86) PCT No.: PCT/US07/67212

§ 371 Date: Apr. 25, 2008

Related U.S. Application Data
(63) Continuation of application No. 60/794,340, filed on Apr. 24, 2006.

(51) Int. Cl. B65G 47/52; B65G 39/20

(52) U.S. Cl. 198/370.08; 198/845

(57) ABSTRACT

Conveyor diverters are disclosed herein. One embodiment of a conveyor diverter comprises an arm comprising a first end and a second end. The arm has a first surface extending between a location proximate the first end and a location proximate the second end. The arm is movable between a first position and a second position. A chain is located within the arm. The chain comprises at least one roller assembly, wherein at least a portion of the roller assembly extends beyond the first surface.

This application claims the benefits of PCT application PCT/U.S.07/67212 filed on Apr. 23, 2007, which claims priority of U.S. provisional application 60/794,340 for CONVEYOR DIVERTER filed on Apr. 24, 2006, which is hereby incorporated for all that is disclosed therein.

### BACKGROUND

Conveyor systems may include diverging conveyors wherein items being transferred via the conveyor system are required to be moved from one conveyor to another. For example, the conveyor system may include a main conveyor and several side conveyors. The side conveyors may be located adjacent the main conveyor so as to intersect the main conveyor at angles.

Items being transported via the main conveyor may need to be moved to a side conveyor. An arm or member swings into the path of the item, which causes the item to be diverted to a side conveyor. The above-described angle is required due to limitations in the speed in which items can be diverted from the main conveyor to side conveyors. For example, if an item is moving at a high velocity and contacts the arm, the item could become damaged.

In order to use less space in a conveyor system, the angle between the side conveyor and the main conveyor should be as close to perpendicular as possible. However, as the angle approaches perpendicular, items being conveyed on the main conveyor tend to strike the arm rather than be guided by the arm, which can damage the items. In addition, the items may not get diverted to the side conveyor, which will clog the main conveyor and require maintenance to unclog the main conveyor.

### BRIEF DESCRIPTION OF THE DRAWINGS

FIG. 1 is a top plan view of an embodiment of a conveyor system.

FIG. 2 is a top perspective view of an embodiment of the diverter of FIG. 1.

FIG. 3 is a side elevation view of the diverter of FIG. 2.

FIG. 4 is a top plan view of the diverter of FIG. 2.

FIG. 5 is a side perspective view of an embodiment of the first end of the arm of FIG. 2 with a section of the upper chassis removed.

FIG. 6 is a view of the first end of the arm of FIG. 5 with a section of chain removed.

FIG. 7 is a partial, top perspective view of an embodiment of the diverter of FIG. 2.

FIG. 8 is a top perspective view of an embodiment of a diverter that has a curved arm.

FIG. 9 is a top plan view of the diverter of FIG. 8.

FIG. 10 is a top plan view of an embodiment of a conveyor using the diverter of FIG. 8.

FIG. 11 is a side view of a diverter having a plurality of arms.

### SUMMARY

Conveyor diverters are disclosed herein. One embodiment of a conveyor diverter comprises an arm comprising a first end and a second end. The arm has a first surface extending between a location proximate the first end and a location proximate the second end. The arm is movable between a first position and a second position. A chain is located within the arm. The chain comprises at least one roller assembly, wherein at least a portion of the roller assembly extends beyond the first surface.

### DETAILED DESCRIPTION

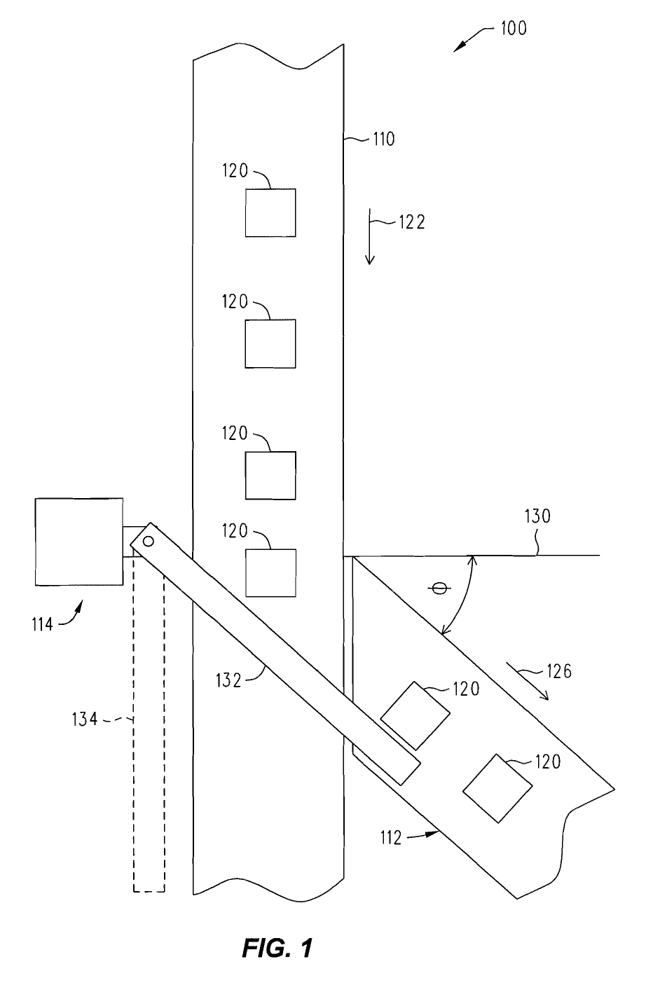

A top plan view of an embodiment of a conveyor system 100 is shown in FIG. 1. The conveyor system 100 includes a main conveyor 110, a side conveyor 112, and a diverter 114. The main conveyor 110 transports items 120 in a direction 122. The main conveyor 110 may be, as an example, a belt-type conveyor, wherein the items 120 are moved by way of a moving belt. The side conveyor 112 moves the items 120 in a direction 126. As described in greater detail below, the diverter 114 serves to move selected items 120 from the main conveyor 110 to the side conveyor 112. In some embodiments, the conveyor system 100 may have a plurality of side conveyors. However, only the one side conveyor 112 is described herein.

For reference purposes, an axis 130 extends perpendicular to the direction 122, which in the embodiment described in FIG. 1 is also perpendicular to the main conveyor 110. An angle θ, exists between the axis 130 and the direction 126. The diverter 114 described herein reduces the angle θ relative to conventional conveyor systems, which enables more side conveyors to be located adjacent a section of the main conveyor 110. Therefore, the length of the main conveyor 110 may be reduced relative to conventional conveyor systems. As described below, the diverter 114 also reduces the chance of damage to the items 120 when being diverted to the side conveyor 112 when the angle θ is reduced.

The diverter 114 includes an arm 132 that swings between a first position and a second position. The first position is noted by the dashed lines 134. When the arm 132 is in the first position, the arm 132 does not contact items 120 being transported via the main conveyor 110. Accordingly, the items 120 are able to travel along the main conveyor 110. However, when the arm 132 is in the second position as noted by the solid lines of arm 132, the arm 132 contacts the items 120. Thus, when the arm 132 is in the second position, the items in the proximity of the arm 132 are diverted on to the side conveyor 112.

It is noted that the diverter 114 must move the items 120 from the main conveyor 110 to the side conveyor 112 without damaging the items. It is also noted that the items 120 may be traveling at a very high speed on the main conveyor 110, which complicates the transferring the items to the side conveyor 112 without damaging the items 120.

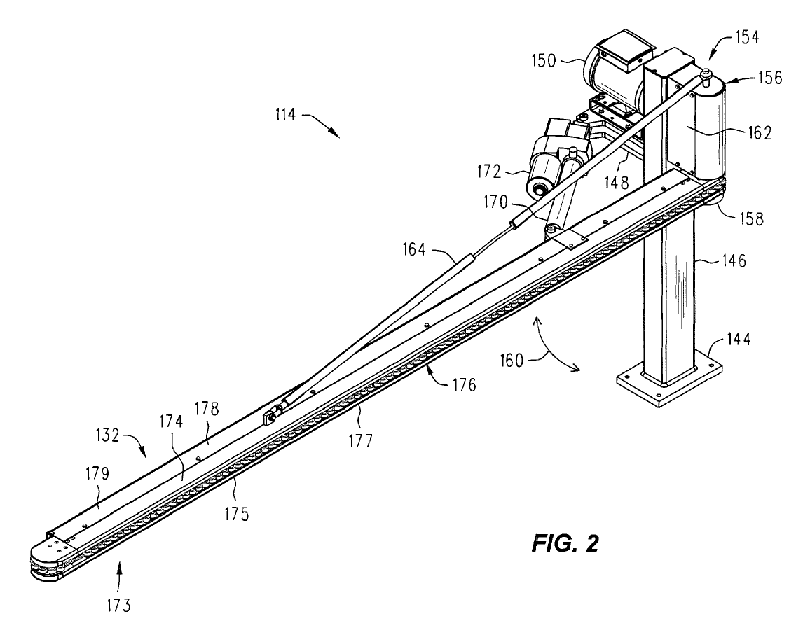

A top perspective view of an embodiment of the diverter 114 is shown in FIG. 2. The diverter 114 of FIG. 2 is configured to be attached to a floor or other stable surface proximate a conveyor. Thus, the diverter 114 includes a platform 144 that mounts to the floor or surface. Other embodiments of the diverter 114 are configured to be attached to the conveyor system 110, FIG. 1. Attached to the platform 144 is a support 146, which may be a metal member. In the embodiment of the diverter 114 described herein, both the platform 144 and the support 146 are immovable relative to the conveyor. Attached to the support 146 is a motor platform 148 that serves to support a motor 150.

Also attached to the support 146 is a hinge 154. The hinge 154 includes an upper portion 156 and a lower portion 158. A cover 162 covers mechanisms and the like located in and associated with the hinge 154. The arm 132 is pivotally attached to the lower portion 158 of the hinge 154, so that the arm 132 may move along an arc 160. A support bar 164 is pivotally attached to the upper support portion 156 and the arm 132. The support bar 164 serves to reduce the torque applied on the lower portion 158 by the arm 132, which enables the lower portion 158 to be smaller.

A movement arm 170 is attached between the arm 132 and a mount, which in the embodiment of FIG. 2 is the motor platform 148. Associated with the movement arm 170 is a control mechanism 172 that serves to control the movement of the movement arm 170. The movement arm 170 serves to move the arm 132 to preselected positions and to maintain the arm 132 in these positions as it is being contacted by items 120, FIG. 1. In some embodiments, the movement arm 170 is a hydraulic device and the control mechanism 172 is a hydraulic control.

The arm 132 includes a chassis 173 having an upper chassis portion 174 (sometimes referred to as a first chassis portion) and a lower chassis portion 175 (sometimes referred to as a second chassis portion). Sandwiched between the upper chassis portion 174 and the lower chassis portion 175 is a chain 176. As described in greater detail below, the chain 176 facilitates the movement of items 120, FIG. 1, that contact the arm 132. The chain 176 extends slightly from a front side 177 (also referred to as a first side) of the arm 132 wherein items 120, FIG. 1, being diverted contact chain 176 proximate the front side 177 of the arm 132. A back side 178 of the arm 132 has a cover 179 that serves to cover the chain 176. Some embodiments of the diverter 114 do not include the cover 179.

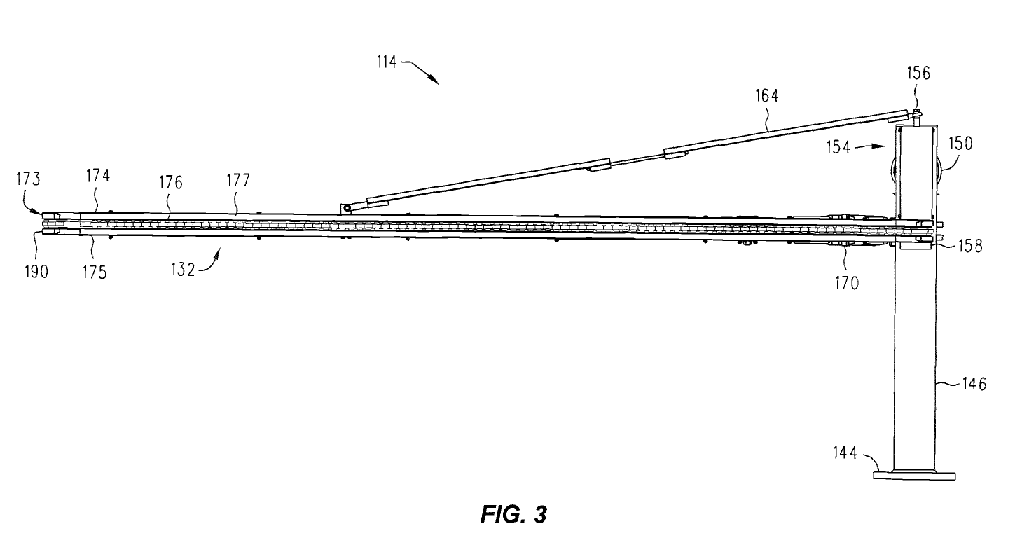

FIG. 3 is a side elevation view of the diverter 114. FIG. 3, shows the chain 176 sandwiched between the upper chassis portion 174 and the lower chassis portion 175. As described in greater detail below, the chain 176 facilitates the movement of items 120, FIG. 1, from the main conveyor 110 to the side conveyor 112. More specifically, as items 120 contact the chain 176, the chain 176 moves the items 120 to the side conveyor 112. As described in greater detail below, the use of the chain 176 reduces the friction between the arm 132 and items being diverted. Therefore, the diversion from the main conveyor 110 to the side conveyor 112 can occur at a higher speed, a reduced angle θ, and with less damage to the items 120, FIG. 1.

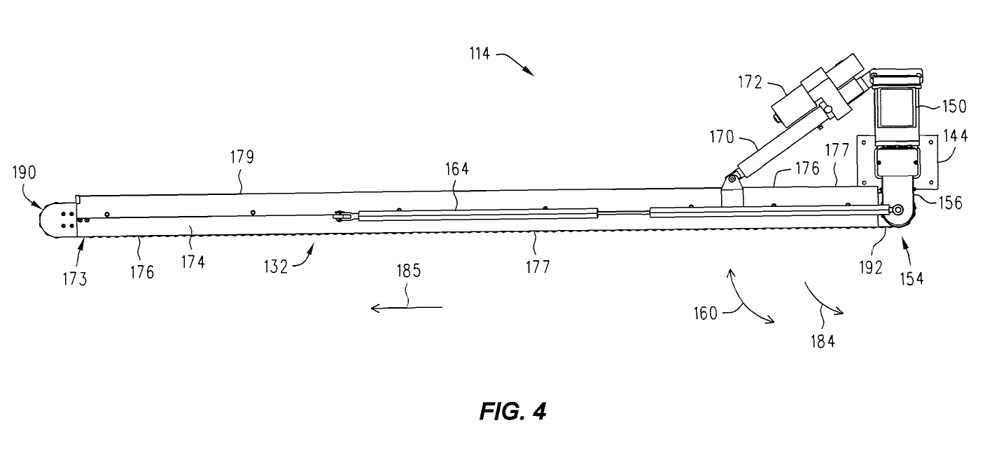

A top plan view of the diverter 114 is shown in FIG. 4 with the movement arm 170 retracted. The arm 132 may move in the direction 184 when the movement arm 170 extends. As shown in FIG. 4, the support arm 164 is able to pivot with the arm 132 so as to provide support to the arm 132 during the whole sweep of movement. With reference to FIG. 1, the arm 132 as shown in FIG. 4 is in the first position as noted by the dashed lines 134.

As also shown in FIG. 4, the chain 176 extends slightly from the chassis 173. This extension of the chain 176 causes items being diverted to contact the chain 176 and not the chassis 173. As described in greater detail below, some embodiments of the chain 176 include rollers that further facilitate the movement of items that contact the arm 132. In these embodiments, the rollers extend from the chassis 173 so as to contact items being conveyed or otherwise diverted. The chain 176 moves in a direction 185 with reference to the front side 177 of the arm 132, which is a clock wise direction when viewed from the top plan view of FIG. 4. Accordingly, items contacting the arm 132 are forced to move in the direction 185 by the chain 176.

For reference purposes, the arm 132 has a first end 190 that is located opposite the hinge 154 and a second end 192 that is located proximate the hinge 154, wherein the direction 185 extends from the second end 192 toward to the first end 190.

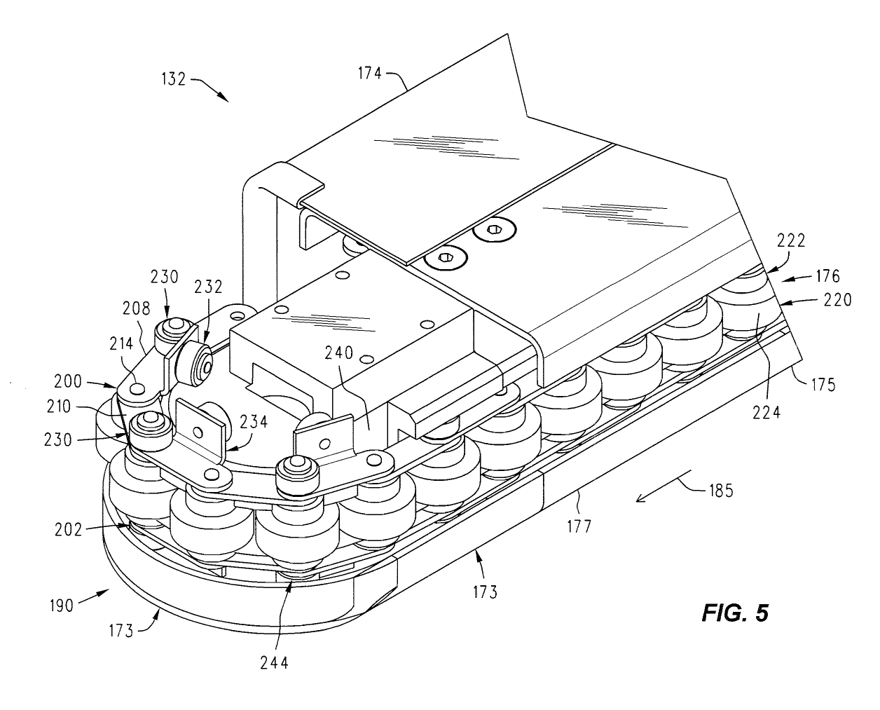

An exploded perspective view of and embodiment of the first end 190 of the arm 132 is shown in FIG. 5. For illustration purposes, the view of FIG. 5 has a portion of the upper chassis portion 174 removed. The chain 176 include a plurality of upper links 200 and lower links 202. Both the upper links 200 and lower links 202 include a plurality of outer links 208 and inner links 210 that are pivotally connected to one another by way of shafts 214. The shafts 214 extend between the upper links 200 and the lower links 202. A plurality of roller assemblies 220 are located between the upper links 200 and the lower links 202 wherein the shafts 214 extend through the roller assemblies 220. As described in greater detail below, the roller assemblies 220 rotate or spin as the chain 176 moves. The direction of rotation of the roller assemblies 220 is such that the portion of the roller assemblies that extend beyond the chassis 173 move in the direction 185. By accelerating the items in the direction 185, the speed at which the items 120, FIG. 1, are diverted from the main conveyor 110, FIG. 1, to the side conveyor 112, FIG. 1 may be increased, with less damage to the items 120.

In the embodiment of the roller assemblies 220 described herein, the roller assemblies 220 include inner rollers 222 and outer rollers 224. The outer rollers 224 are movable relative to the inner rollers 222, wherein friction exists between the inner rollers 222 and the outer rollers 224. When an item first contacts the outer rollers 224, the frictional force between the inner rollers 222 and the outer rollers 224 due to the force applied by the item is minimal. Accordingly, the outer rollers 224 may spin relative to the inner rollers 222, which causes the items initially to move in the direction 185 at a slow speed. The force exerted by the items on the outer rollers 224 increases due to the items being forced against the arm 132 by the their movement on the main conveyor 110, FIG. 1. The increased force applied to the outer rollers 224 increases the frictional force between the inner rollers 222 and the outer rollers 224 increases. The increased friction, in turn, causes less slippage between the inner rollers 222 and the outer rollers 223. Thus, the items are accelerated to a speed in the direction 185 that is proportional to the speed at which the inner rollers 222 rotate. It is noted that the angular velocity of the outer rollers 224 may exceed the velocity of the chain 176 as described in greater detail below.

Attached to the upper links 200 are vertical rollers 230 (sometimes referred to as second rollers) and horizontal rollers 232 (sometimes referred to as first rollers). As shown in FIG. 5, the outer links 208 may include brackets 234 that support the vertical rollers 232. The shafts 214 may pass through the horizontal rollers 232 so as to connect them to the upper links 200. The vertical rollers 230 and the horizontal rollers 232 serve to stabilize the chain 176 during operation.

The embodiment of the arm 132 shown in FIG. 5 has a platform 240, wherein the vertical rollers 232 contact the platform 240 and may roll relative to the platform 240. The horizontal rollers 230 may contact the inner surface of the upper chassis portion 174 and may roll relative to the inner surface. It is noted that similar or identical rollers may be associated with or connected to the lower links 202. Likewise, the arm 132 may have a platform on which vertical rollers connected to the lower links 202 contact. In addition, vertical rollers associated with the lower links 202 may contact or roll relative to the inner surface of the lower chassis portion 175. In some embodiments all or some of the rollers are not connected to the lower links 202. The platform 240 may be substantially perpendicular to the inner surface of the upper chassis 174.

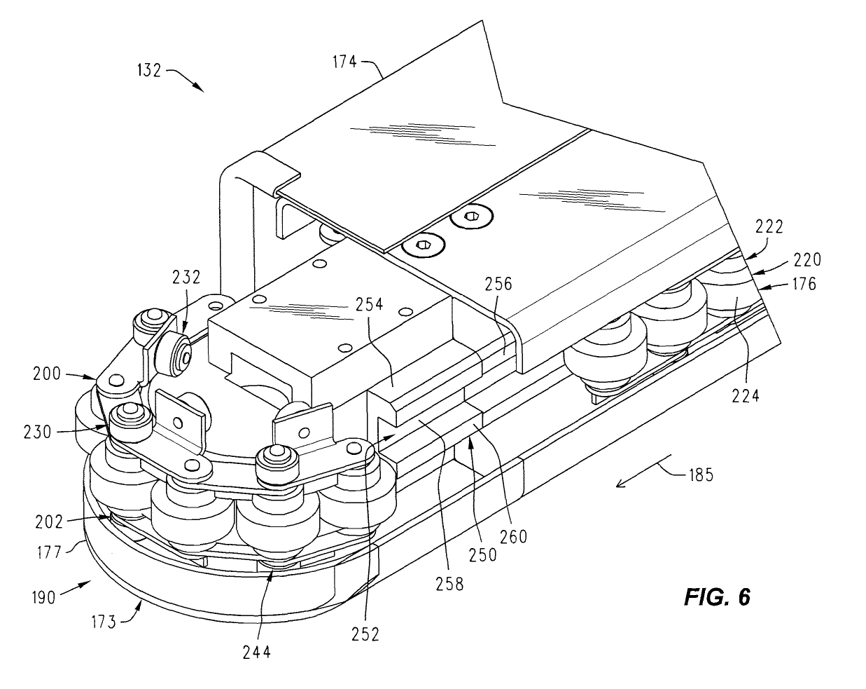

Another view of the first end 190 of the arm 132 is shown in FIG. 6. The view of FIG. 6 has a portion of the chain 176 removed to provide a view of the inner portion of the arm 132. As shown, the embodiment of the chain 176 of FIG. 6 has lower horizontal rollers 244 attached to the lower links 202.

As shown by the removed portion of the chain 176, the embodiment of the arm 132 shown in FIG. 6 has a rail 250 located therein. The rail 250 has a channel 252 located or formed therein. The channel 252 is sized to receive the outer rollers 224. The rail 250 has an upper surface 254, a first outer surface 256, an inner surface 258, and a second outer surface 260. In embodiment of the arm 132 of FIG. 6, the inner rollers 222 contact the first outer surface 256 and the second outer surface 260 of the rail 250. The contact causes the inner rollers 222 to spin as the chain 176 moves. Likewise, the outer rollers 224 also spin and have a greater angular velocity than the inner rollers 222. Therefore, an item may be conveyed by the chain 176 wherein the velocity of the item is greater than the velocity of the chain 176. As described above, friction between the inner rollers 222 and the outer rollers 224 can be used to accelerate items at a slower rate than conventional diverters.

In some embodiments, the outer rollers 224 may contact the inner surface 258 of the channel 252. This contact will cause the outer rollers 224 to spin at a rate proportional to the velocity of the chain 176.

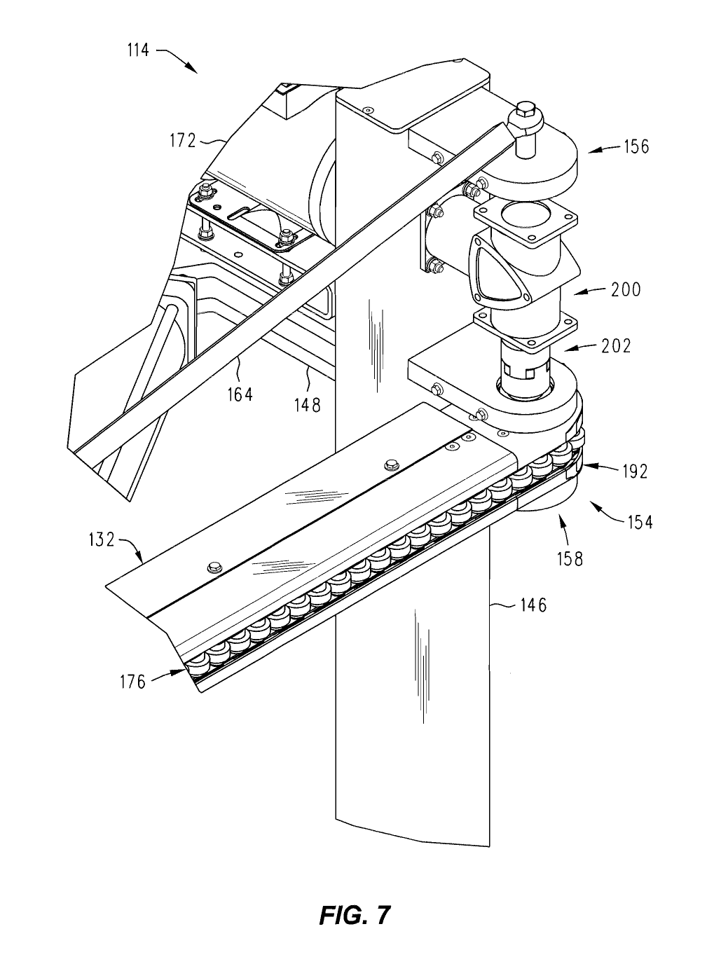

A partial view of the diverter 114 at the location of the second end 192 of the arm 132 is shown in FIG. 7. The view of FIG. 7 includes the hinge 154 with the cover 162, FIG. 2, removed so as to show the mechanisms within the hinge 154. One mechanism located within the hinge 154 is a gear box 200 that is connected to a drive mechanism 202. Within the second end 192 of the arm 132 is a sprocket or the like attached to the drive mechanism 202. The sprocket engages the chain 176. As shown, the drive mechanism 202 passes through a section of the lower portion 158 of the hinge 154. The gear box 200 is a right angle device wherein the motor 150 rotates a horizontal shaft. Based on the rotation, the gear box 200 rotates the vertical drive mechanism 202, which rotates the above-described sprocket. The rotation of the sprocket causes the chain 176 to move.

As shown in FIG. 7, the arm 132 may swing about the hinge 158. Regardless of the location of the arm 132, the drive mechanism 202 will always be able to rotate and cause the sprocket to rotate. Therefore, the chain 176 is able to be moved regardless of the position of the arm 132.

The use of the chain 176, FIGS. 5 and 6, with the roller assemblies 220 enables the diverter 114, FIG. 1, to quickly move items 120 from the main conveyor 110 to the side conveyor 112 without damaging the items 120. Thus, the angle θ may be reduced and more side conveyors may be located adjacent a second of the main conveyor 110.

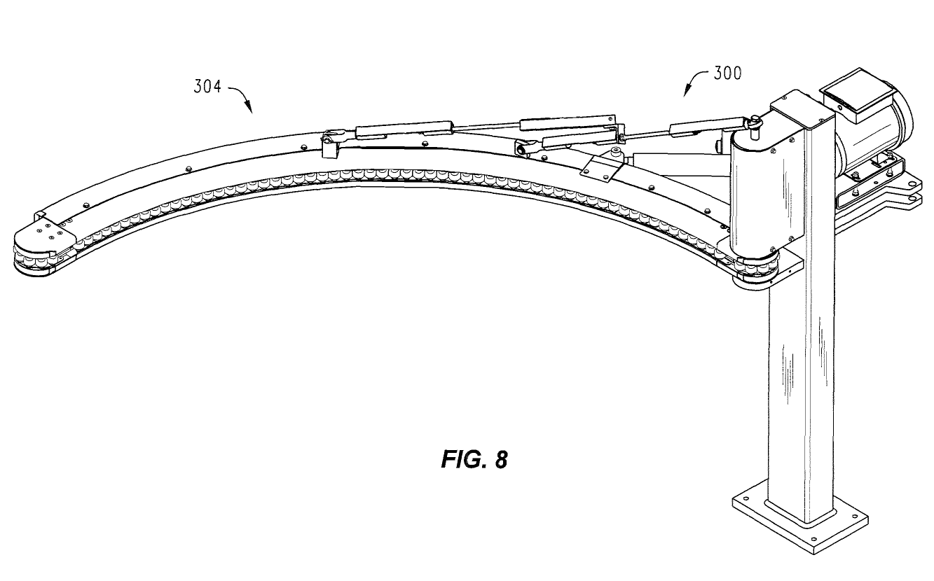

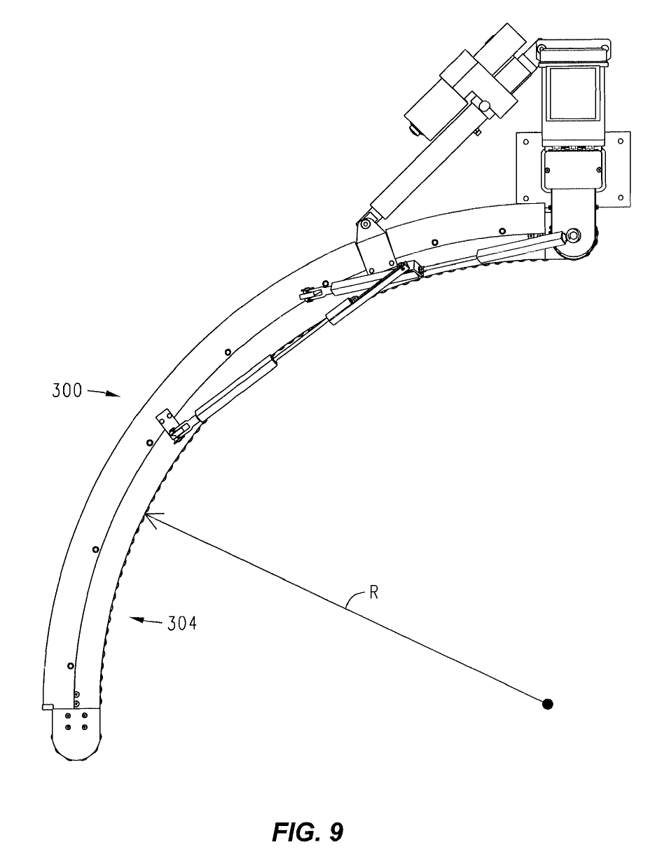

Another embodiment of a diverter 300 is shown in FIG. 8 and has a curved arm 304 rather than the straight arm 132, FIG. 2. FIG. 9 is a top plan view of the diverter 300. Other than the curved arm 304, the diverter 300 is substantially similar to the diverter 114 of FIG. 2. In the embodiment of the diverter 300 of FIG. 9, the curved arm 304 has a radius R. It is noted that the radius R may be varied depending on the application of the diverter 220. It is noted that the entire length of the curved arm 304 does not need to be curved. Rather, a portion may be straight and another portion may be curved. In another embodiment, only the front side of the arm 304 is curved. Thus, the chain travels along the curve.

With additional reference to FIGS. 5 and 6, the configuration of the upper chassis portion 174 and the lower chassis portion 175 serve to contain the chain 176 from exiting the front side 177 of the arm 132, 304. For example, the vertical rollers 230 contact the inner surfaces fo the upper chassis portion 174 and the lower chassis portion 175. The contact serves to maintain the chain 176 within the arm 132, 304. With this configuration, the arm 132, 304 may be operated with the curve. In addition, the arm 132, 304 need not be operated with the chain 176 moving about a horizontal plane. Rather, the arm 132, 304 can operate with the chain 176 moving about a slant, such as an incline or decline.

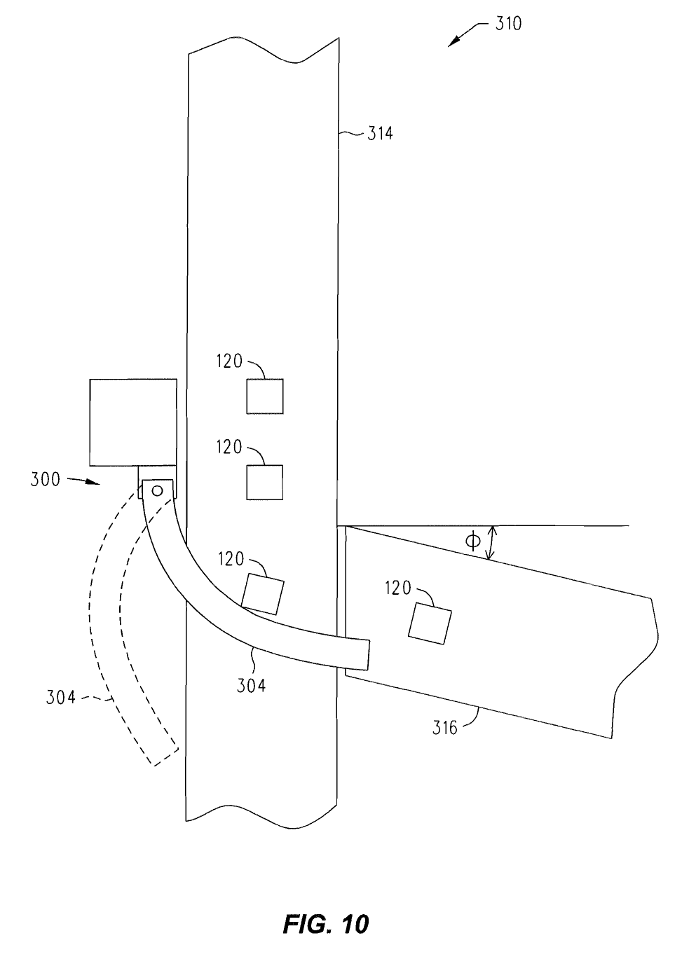

A portion of an embodiment of a conveyor 310 that includes the diverter 300 is shown in FIG. 10. As with the conveyor 100 of FIG. 1, the conveyor 310 includes a main conveyor 314 and a side conveyor 316. The diverter 310 serves to divert items 120 from the main conveyor 314 to the side conveyor 316. When the curved arm 304 is in a first position as noted by the dashed lines, the items continue on the main conveyor 314. When the curved arm 304 is in the second position as noted by the solid lines, the items 120 contact the curved arm 304 and are diverted to the side conveyor 316.

The side conveyor 316 intersects the main conveyor 314 at an angle φ. The curved arm 304 enables the items 120 to be diverted substantially perpendicular to the main conveyor 314. Therefore, the angle φ is able to be much less than the angle θ of the conveyor 100, FIG. 1. Thus, a greater number of side conveyors may be associated with a section of the main conveyor using the diverter 300 than would be using a diverter having a straight arm.

Having described some embodiments of the diverters 114, 300, other embodiments will now be described. With reference to FIGS. 3 and 8, in some embodiments, the diverters 114, 300 include a plurality of arms 132, 304. For example, the diverters 114, 300 may include a plurality of hinges, wherein an arm is pivotally connected to each hinge in a substantially similar manner as the arms 132, 304 are connected.

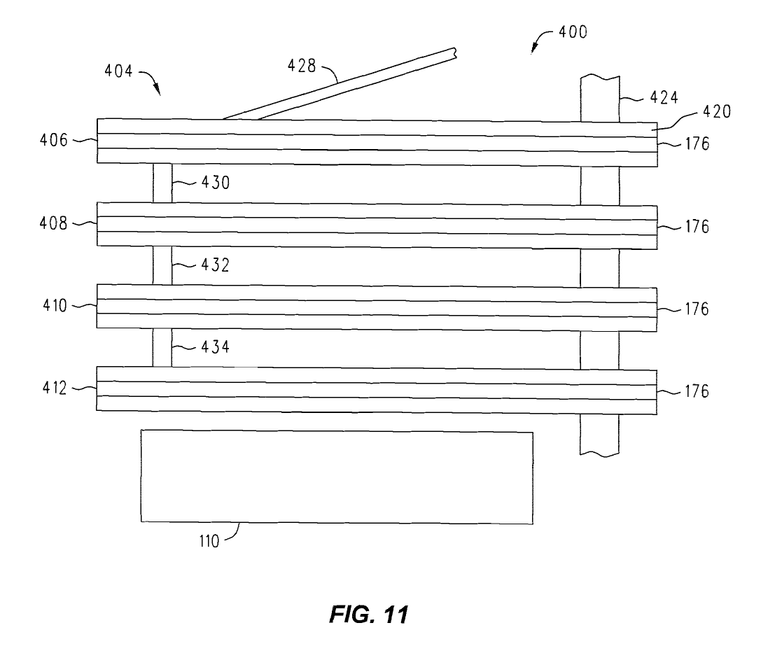

An example of such an embodiment is shown in FIG. 11, which is a side view of a diverter 400 having a plurality of arms 404. The plurality of arms 404 are referred to individually as the first arm 406, the second arm 408, the third arm 410, and the fourth arm 412. All the arms 404 are substantially identical to each other, thus, the following description of the first arm 406 is applicable to all the arms 404.

The first arm 406 is substantially identical to the above described arm 132, 304. Accordingly, the arms 404 may be straight or curved as described above. The first arm 406 has a first surface 420 that contacts items moving via the first conveyor 110. A chain 176 is located proximate the first surface 420 and extend through the first surface 420. The chain 176 is substantially identical to the chain 176 described above.

A support member 424 extends through or attaches to all the arms 404. The support member 424 serves as an pivot point for the arms 404. In addition, the support member 404 may have a shaft or the like located therein that serves to rotate the chains 176 in each of the arms 404. The support member is substantially similar to the hinge 154 described above.

A support arm 428 is attached to the first arm 406. The support arm 428 is substantially similar to the support arm 164 described above and serves to support the weight of the arms 404 while allowing the arms 404 to pivot. A plurality of supports 430, 432, 434 connect arms 404 to one another so that the support arm 428 carries the weight of all the arms 404. More specifically, a first support 430 is connected between the first arm 406 and the second arm 408, a second support 432 is connected between the second arm 408 and the third arm 410, and a third support is connected between the third arm 410 and the fourth arm 412. By connecting the arms 404, their weight is carried by the support arm 428 and they pivot in unison.

The plurality of arms 404 used in the diverter 400 increases the area in which items contact the arms 404, which enables the diverter 400 to divert larger items. In some embodiments, all the arms 404 are controlled by a single controller wherein the single controller causes all the arms 404 to move in unison as describe above.

In other embodiments, a plurality of controllers are used to move the arms 404 independent of one another. In such an embodiment, the arms 430, 432, 434 are not used. In some embodiments as described above, a single motor is used to move the chains 176 of all the arms 404. In other embodiments, a plurality of motors are used to move the plurality of chains 176.

The arms 132, 304 have been described herein using a single chain 176. In some embodiments, the arms 132, 304 may have a plurality of chains 176 wherein the chains 176 are stacked on each other. The use of a plurality of chains enables a greater contact with items being conveyed.

Having described the diverters 114, 300, 400, their operation will now be described. The following description will be based on the diverter 114 and its relation to the conveyor 100, FIG. 1. It is noted that the operation of the diverters 300, 400 are substantially similar to the operation of the diverter 114. The diverter 114 serves to divert select items 120 from the main conveyor 110 to the side conveyor 112. When an item 120 is to be diverted, the arm 132 moves from the first position to the second position where it is able to contact the moving item.

With additional reference to FIG. 6, the moving items 120 that are to be diverted contact the outer rollers 224 on the chain 176. Because of the friction between the inner rollers 222 and the outer rollers 224, the items 120 are not instantly subjected to the velocity of the moving chain 176. Rather, the items 120 being diverted exert an increasing force on the outer rollers 224 as they are moved in the direction 122 by the main conveyor 110. The increasing force increases the frictional force between the inner rollers 222 and the outer rollers 224. The increased frictional force causes the outer rollers 224 to rotate with, rather than slide relative to, the inner rollers 222. Thus, the velocities of the items 120 being conveyed, by way of their contact with the outer rollers 224, increase. The items 120 are then rapidly conveyed to the side conveyor 112. This movement enables the conveyor system 100 to use a smaller angle θ than conventional conveyor systems.

The chain is maintained in the chassis by way of the rollers 230, 232, 244, and horizontal rollers located adjacent the inner surface of the lower chassis portion 175. As set forth above, the vertical rollers 232 serve to maintain the height of the chain 176 within the chassis 173. The horizontal rollers 230, 244 serve to keep the chain 176 from extending beyond the chassis 173. They also serve to reduce the friction between the chain 176 and the chassis 173. This function becomes more noticeable with regard to the curved arm 304, FIG. 9. Tension on the chain 176 in a curved arm will likely force the chain 176 against the inner surface of the upper and lower chassis portions 174, 175. Thus, the outer rollers 224 will not extend beyond a preselected distance from the chassis 173 when they are used within the curved arm 304.

It is noted that the outer rollers 224 are exposed on the first end 190 of the arm 132. This exposure facilitates the movement of the items all the way to the first end 190 of the arm. Thus, the items do not encounter a portion of the arm 132 that does not have a moving chain, which would cause the items to slow.

The conveyor system 100 has been described as being operated on a horizontal plane. However, the configuration of the chain 176 within the arms 132, 304, 404 enables the conveyor system 100 to be operated at an angle. For example, the main conveyor 110 and the side conveyors 112 may be inclined or declined. Accordingly, the arms 132, 304, 404 may move parallel to the inclined or declined plane because the chain 176 is retained within the arms 132, 304, 404 and will not fall out of the arms 132, 304, 404 if they are not maintained horizontal.

What is claimed is:

1. A conveyor diverter comprising:
an arm comprising a first end and a second end, said arm comprising a first surface extending between a location proximate said first end and a location proximate said second end; said arm being movable between a first position and a second position; and
a chain, said chain comprising at least one roller assembly, wherein at least a portion of said at least one roller assembly extends beyond said first surface.

2. The conveyor diverter of claim 1, wherein at least a portion of said first surface between said first end and said second end is curved.

3. The conveyor diverter of claim 1, wherein said at least one roller assembly comprises an inner roller comprising an exterior surface and an outer roller comprising an inner surface, wherein said outer surface of said inner roller contacts said inner surface of said outer roller.

4. The conveyor diverter of claim 3, wherein said outer roller is movable relative to said inner roller.

5. The conveyor diverter of claim 3, wherein said arm comprises a channel located adjacent said chain and wherein said outer roller is receivable within said channel.

6. The conveyor diverter of claim 5, wherein said arm comprises a surface located adjacent said channel and wherein said inner roller is contactable with said surface.

7. The conveyor diverter of claim 1, wherein said arm comprises a first chassis portion and a second chassis portion, and wherein said chain is located between said first chassis portion and said second chassis portion, said first surface being a section of said first chassis portion and a section of said second chassis portion.

8. The conveyor diverter of claim 7, wherein said first chassis portion comprises an inner surface, wherein said chain comprises at least one first roller, and wherein said at least one first roller is contactable with said inner surface.

9. The conveyor diverter of claim 8, wherein said inner surface is located opposite said first surface.

10. The conveyor diverter of claim 8, wherein said arm comprises a platform, said platform being on a plane that is substantially perpendicular to a plane of said inner surface, and wherein said chain comprises at least one second roller, said at least one second roller being contactable with said platform.

11. The conveyor diverter of claim 8, wherein said arm comprises a surface, wherein said surface is substantially parallel to said inner surface, and wherein said inner roller is contactable with said surface.

12. A conveyor diverter comprising:
a support member;
an arm pivotally connected to said support member, said arm comprising:
a first end and a second end
a first surface extending between a location proximate said first end and proximate said second end; and
a chain, said chain comprising at least one roller assembly, wherein at least a portion of said at least one roller assembly extends beyond said first surface.

13. The conveyor diverter of claim 12, wherein said at least one roller assembly comprises an inner roller having an exterior surface and an outer roller having an interior surface, and wherein said outer surface of said inner roller contacts said inner surface of said outer roller.

14. The conveyor diverter of claim 13, wherein said arm further comprises a channel, said channel comprising a recessed portion and a raised portion, wherein said outer roller is receivable within said recessed portion.

15. The conveyor diverter of claim 14, wherein said recessed portion of said channel comprises a surface and wherein said at least one outer roller is contactable with said surface.

16. The conveyor diverter of claim 14, wherein said at least one inner roller is contactable with said raised portion.

17. The conveyor diverter of claim 12, wherein said arm comprises a second surface, said second surface being substantially parallel to said first surface, wherein said chain comprises at least one first roller, and wherein said at least one first roller is contactable with said first surface.

18. The conveyor of claim 12, wherein said arm further comprises a platform, said platform being substantially perpendicular to said first surface, and wherein said chain comprises at least one second roller, said at least one second roller being contactable with said platform.

19. The conveyor diverter of claim 12 and further comprising a plurality of arms pivotally connected to said support member.

20. The conveyor diverter of claim 12, wherein at least a portion of said arm is arcuate.

21. A conveyor chain comprising:
a plurality of first links;
a plurality of second links, said first links and said second links being connected to each other by way of shafts;
at least one inner roller associated with at least one shaft, wherein said at least one inner roller is rotatable about an axis defined by said at least one shaft, said at least one inner roller being located between at least one first link and at least one second link; and
at least one outer roller associated with said at least one inner roller, said at least one outer roller being contactable and rotatable about said at least one inner roller.

22. The conveyor chain of claim 21, wherein said shaft defines a first axis, and further comprising at least one third roller, wherein said at least one third roller is located proximate said at least one first link and rotatable about an axis parallel to said first axis.

23. The conveyor chain of said 22, wherein said at least one third roller is rotatable about said shaft.

24. The conveyor chain of claim 21, wherein said shaft defines a first axis, and further comprising at least one fourth roller, wherein said at least one fourth roller is located proximate said at least one second link and rotatable about an axis parallel to said first axis.

25. The conveyor chain of claim 21, wherein said shaft defines a first axis, and further comprising at least one fifth roller, wherein said at least one fifth roller is located proximate said at least one first link and rotatable about an axis perpendicular to said first axis.

26. The conveyor chain of claim 25, wherein said at least one first link comprises at least one first portion and at least one second portion, wherein said shaft extends through said at least one first portion and said at least one second portion, said at least one first portion being movable relative to said at least one second portion about said shaft; said at least one fifth roller being connected to said at least one first portion.

27. The conveyor chain of claim 21, wherein said shaft defines a first axis, and further comprising at least one sixth roller, wherein said at least one sixth roller is located proximate said at least one second link and rotatable about an axis perpendicular to said first axis.

28. The conveyor chain of claim 27, wherein said at least one second link comprises at least one first portion and at least one second portion, wherein said shaft extends through said at least one first portion and said at least one second portion, said at least one first portion being movable relative to said at least one second portion about said shaft; said at least one sixth roller being connected to said at least one first portion.
